(19) United States
(12) Patent Application Publication
(10) Pub. No.: US 2015/0189009 A1
(43) Pub. Date: Jul. 2, 2015

(54) DISTRIBUTED MULTI-LEVEL STATELESS LOAD BALANCING

(71) Applicant: Jeroen van Bemmel, Calgary (CA)

(72) Inventor: Jeroen van Bemmel, Calgary (CA)

(73) Assignee: Alcatel-Lucent Canada Inc., Ottawa (CA)

(21) Appl. No.: 14/143,499

(22) Filed: Dec. 30, 2013

(51) Int. Cl. H04L 29/08

(52) U.S. Cl. CPC H04L 67/1008; H04L 67/141

(57) ABSTRACT

A capability is provided for performing distributed multi-level stateless load balancing. The stateless load balancing may be performed for load balancing of connections of a stateful-connection protocol (e.g., Transmission Control Protocol (TCP) connections, Stream Control Transmission Protocol (SCTP) connections, or the like). The stateless load balancing may be distributed across multiple hierarchical levels. The multiple hierarchical levels may be distributed across multiple network locations, geographic locations, or the like.

### TECHNICAL FIELD

The disclosure relates generally to load balancing and, more specifically but not exclusively, to stateless load balancing for connections of a stateful-connection protocol.

### BACKGROUND

As the use of data center networks continues to increase, there is a need for a scalable, highly-available load-balancing solution for load balancing of connections to virtual machines (VMs) in data center networks. Similarly, various other types of environments also may benefit from a scalable, highly-available load-balancing solution for load-balancing of connections.

### SUMMARY OF EMBODIMENTS

Various deficiencies in the prior art are addressed by embodiments for distributed multi-level stateless load balancing configured to support stateless load balancing for connections of a stateful-connection protocol.

In at least some embodiments, an apparatus includes a processor and a memory communicatively connected to the processor. The processor is configured to receive an initial connection packet of a stateful-connection protocol at a first load balancer configured to perform load balancing across a set of processing elements, where the initial connection packet of the stateful-connection protocol is configured to request establishment of a stateful connection. The processor also is configured to perform a load balancing operation at the first load balancer to control forwarding of the initial connection packet of the stateful-connection protocol toward a set of second load balancers configured to perform load balancing across respective subsets of processing elements of the set of processing elements.

In at least some embodiments, a method includes using a processor and a memory to perform a set of steps. The method includes a step of receiving an initial connection packet of a stateful-connection protocol at a first load balancer configured to perform load balancing across a set of processing elements, where the initial connection packet of the stateful-connection protocol is configured to request establishment of a stateful connection. The method also includes a step of performing a load balancing operation at the first load balancer to control forwarding of the initial connection packet of the stateful-connection protocol toward a set of second load balancers configured to perform load balancing across respective subsets of processing elements of the set of processing elements.

In at least some embodiments, a computer-readable storage medium stores instructions which, when executed by a computer, cause the computer to perform a method. The method includes a step of receiving an initial connection packet of a stateful-connection protocol at a first load balancer configured to perform load balancing across a set of processing elements, where the initial connection packet of the stateful-connection protocol is configured to request establishment of a stateful connection. The method also includes a step of performing a load balancing operation at the first load balancer to control forwarding of the initial connection packet of the stateful-connection protocol toward a set of second load balancers configured to perform load balancing across respective subsets of processing elements of the set of processing elements.

### BRIEF DESCRIPTION OF THE DRAWINGS

The teachings herein can be readily understood by considering the detailed description in conjunction with the accompanying drawings, in which:

FIG. 1 depicts an exemplary communication system configured to support single-level stateless load balancing;

FIG. 2 depicts an exemplary communication system configured to support distributed multi-level stateless load balancing;

FIG. 3 depicts an embodiment of a method for performing a load balancing operation for an initial connection packet of a stateful-connection protocol; and

FIG. 4 depicts a high-level block diagram of a computer suitable for use in performing functions presented herein.

To facilitate understanding, identical reference numerals have been used, where possible, to designate identical elements common to the figures.

### DETAILED DESCRIPTION OF EMBODIMENTS

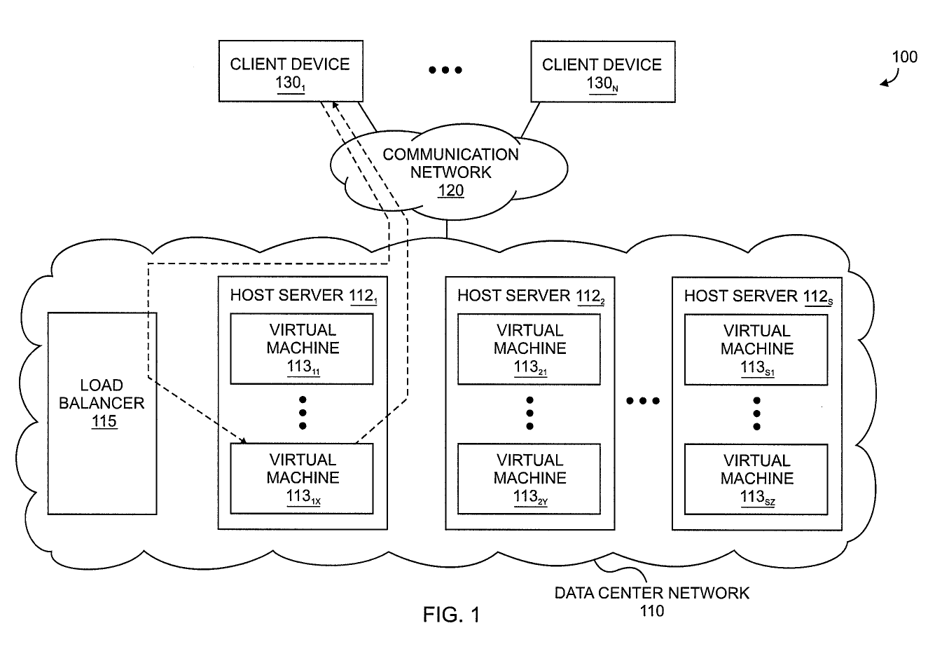

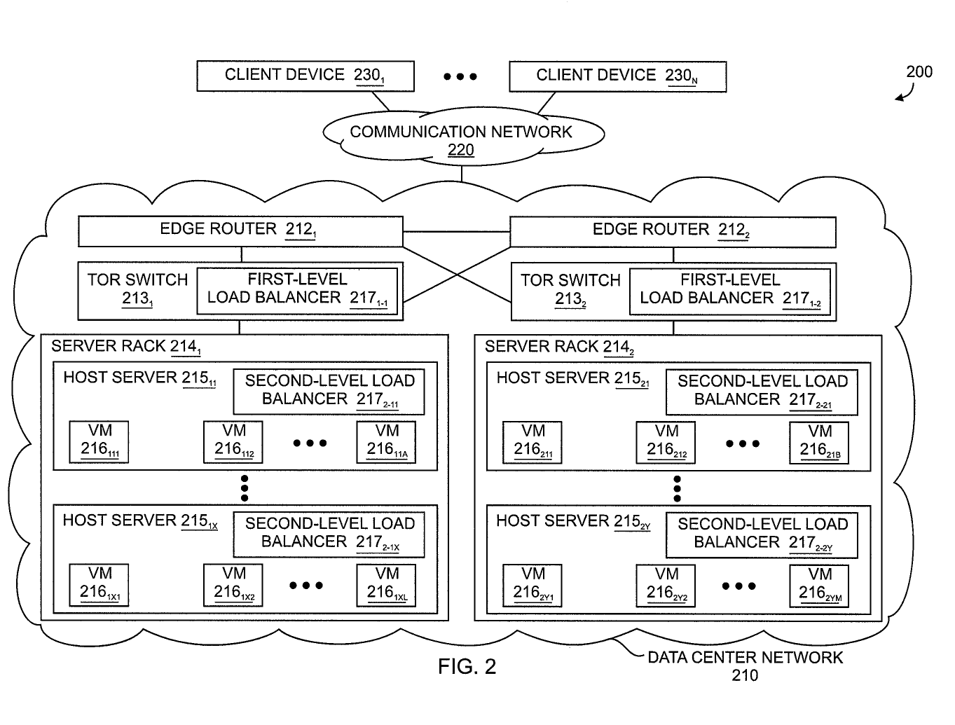

A distributed multi-level stateless load balancing capability is presented herein. The distributed multi-level stateless load balancing capability supports stateless load balancing for connections of a protocol supporting stateful connections (primarily referred to herein as a stateful-connection protocol). The distributed multi-level stateless load balancing capability supports stateless load balancing of connections of a stateful-connection protocol. For example, distributed multi-level stateless load balancing capability may support stateless load balancing of Transmission Control Protocol (TCP) connections, Stream Control Transmission Protocol (SCTP) connections, or the like. The stateless load balancing may be distributed across multiple hierarchical levels. The multiple hierarchical levels may be distributed across multiple network locations, geographic locations, or the like. These and various other embodiments of the distributed multi-level stateless load balancing capability may be better understood by way of reference to the exemplary communication systems of FIG. 1 and FIG. 2.

FIG. 1 depicts an exemplary communication system configured to support single-level stateless load balancing.

The communication system 100 of FIG. 1 includes a data center network (DCN) 110, a communication network (CN) 120, and a plurality of client devices (CDs) 130₁-130_{N} (collectively, CDs 130).

The DCN 110 includes physical resources configured to support virtual resources accessible for use by CDs 130 via CN 120. The DCN 110 includes a plurality of host servers (HSs) 112₁-112_{S} (collectively, HSs 112). The HSs 112₁-112_{S} hosts respective sets of virtual machines (VMs) 113 (collectively, VMs 113). Namely, HS 112₁ hosts a set of VMs 113₁₁-113_{1X} (collectively, VMs 113₁), HS 112₂ hosts a set of VMs 113₂₁-113_{2Y} (collectively, VMs 113₂), and so forth, with HS 112_{S} hosting a set of VMs 113_{S1}-113_{SZ} (collectively, VMs 113_{S}). The HSs 112 each may include one or more central processing units (CPUs) configured to support the VMs 113 hosted by the HSs 112, respectively. The VMs 113 are configured to support TCP connections to CDs 130, via which CDs 130 may access and use VMs 113 for various functions. The DCN 110 may include various other resources configured to support communications associated with VMs 113 (e.g., processing resources, memory resources, storage resources, communication resources (e.g., switches, routers, communication links, or the like), or the like, as well as various combinations thereof). The typical configuration and operation of HSs and VMs in a DCN (e.g., HSs 112 and VMs 113 of DCN 110) will be understood by one skilled in the art.

The DCN 110 also includes a load balancer (LB) 115 which is configured to provide load balancing of TCP connections of CDs 130 across the VMs 113 of DCN 110. The LB 115 may be implemented in any suitable location within DCN 110 (e.g., on a router supporting communications with DCN 110, on a switch supporting communications within DCN 110, as a VM hosted on one of the HSs 112, or the like). The operation of LB 115 in providing load balancing of TCP connections of the CDs 130 across the VMs 113 is described in additional detail below.

The CN 120 includes any type of communication network(s) suitable for supporting communications between CDs 130 and DCN 110. For example, CN 120 may include wireline networks, wireless networks, or the like, as well as various combinations thereof. For example, CN 120 may include one or more wireline or wireless access networks, one or more wireless or wireless core networks, one or more public data networks, or the like.

The CDs 130 include devices configured to access and use resources of a data center network (illustratively, to access and use VMs 113 hosted by HSs 112 of DCN 110). For example, a CD 130 may be a thin client, a smart phone, a tablet computer, a laptop computer, a desktop computer, a television set-top-box, a media player, a server, a network device, or the like. The CDs 130 are configured to support TCP connections to VMs 113 of DCN 110.

The communication system 100 is configured to support a single-level stateless load balancing capability for TCP connections between CDs 130 and VMs 113 of DCN 110.

For TCP SYN packets received from CDs 130, LB 115 is configured to perform load balancing of the TCP SYN packets for distributing the TCP SYN packets across the HSs 112 such that the resulting TCP connections that are established in response to the TCP SYN packets are distributed across the HSs 112. Namely, when one of the CDs 130 sends an initial TCP SYN packet for a TCP connection to be established with one of the VMs 113 of DCN 110, LB 115 receives the initial TCP SYN packet, selects one of the HSs 112 for the TCP SYN packet using a load balancing operation, and forwards the TCP SYN packet to the selected one of the HSs 112. The selection of the one of the HSs 112 using a load balancing operation may be performed using a round-robin selection scheme, load balancing based on a calculation (e.g., <current time in seconds> modulo <the number of HSs 112>, or any other suitable calculation), load balancing based on status information associated with the HSs 112 (e.g., distributing a TCP SYN packet to the least loaded HS 112 at the time when the TCP SYN packet is received), or the like, as well as various combinations thereof. As discussed below, for any subsequent TCP packets sent for the TCP connection that is established responsive to the TCP SYN packet, the TCP packets include an identifier of the selected one of the HSs 112, such that the TCP connection is maintained between the one of the CDs 130 which requested by the TCP connection and the one of the HSs 112 selected for the TCP connection.

For TCP response packets sent from the selected one of the HSs 112 to the one of the CDs 130, the selected one of the HSs 112 inserts its identifier into the TCP response packets (thereby informing the one of the CDs 130 of the selected one of the HSs 112 that is supporting the TCP connection) and forwards the TCP response packets directly to the one of the CDs 130 (i.e., without the TCP response packet having to traverse LB 115). For TCP response packets sent from the selected one of the HSs 112 to the one of the CDs 130, the identifier of the selected one of the HSs 112 may be specified as part of the TCP Timestamp header included by the selected one of the HSs 112, or as part of any other suitable field of the TCP response packets.

Similarly, for subsequent TCP packets (non-SYN TCP packets) sent from the one of the CDs 130 to the selected one of the HSs 112, the one of the CDs 130 inserts the identifier of the selected one of the HSs 112 into the TCP packets such that the TCP packets for the TCP connection are routed to the selected one of the HSs 112 that is supporting the TCP connection. For TCP packets sent from the one of the CDs 130 to the selected one of the HSs 112, the identifier of the selected one of the HSs 112 may be specified as part of the TCP Timestamp header included by the one of the CDs 130, or as part of any other suitable field of the TCP packets.

As noted above, FIG. 1 illustrates a communication system configured to support single-level stateless load balancing of TCP connections. In at least some embodiments, stateless load balancing of TCP connections may be improved by using distributed multi-level stateless load balancing of TCP connections, as depicted and described with respect to FIG. 2.

FIG. 2 depicts an exemplary communication system configured to support distributed multi-level stateless load balancing.

The communication system 200 of FIG. 2 includes a data center network (DCN) 210, a communication network (CN) 220, and a plurality of client devices (CDs) 230₁-230_{N} (collectively, CDs 230).

The DCN 210 includes physical resources configured to support virtual resources accessible for use by CDs 230 via CN 220. The DCN 210 includes a pair of edge routers (ERs) 212₁ and 212₂ (collectively, ERs 212), a pair of top-of-rack (ToR) switches 213₁ and 213₂ (collectively, ToR switches 213), and a pair of server racks (SRs) 214₁ and 214₂ (collectively, SRs 214). The ERs 212 each are connected to each other (for supporting communications within DCN 210) and each are connected to CN 220 (e.g., for supporting communications between elements of DCN 210 and CN 220). The ToR switches 213 each are connected to each of the ERs 212. The ToR switches 213₁ and 213₂ are configured to provide top-of-rack switching for SRs 214₁ and 214₂, respectively. The SRs 214₁ and 214₂ host respective sets of host servers (HSs) as follows: HSs 215₁ (illustratively, HSs 215₁₁-215_{1X}) and HSs 215₂ (illustratively, HSs 215₂₁-215_{2Y}), which may be referred to collectively as HSs 215. The HSs 215 host respective sets of virtual machines (VMs) 216 (collectively, VMs 216). In SR 214₁, HSs 215₁₁-215_{1X} host respective sets of VMs 216₁₁-216_{1X} (illustratively, HS 215₁₁ hosts a set of VMs 216₁₁₁-216_{11A}, and so forth, with HS 215_{1X} hosting a set of VMs 216₁ₓ₁-216_{1XL}). Similarly, in SR 214₂, HSs 215₂₁-215_{2Y} host respective sets of VMs 216₂₁-216_{2Y} (illustratively, HS 215₂₁ hosts a set of VMs 216₂₁₁-216_{21B}, and so forth, with HS 215_{2Y} hosting a set of VMs 216_{2Y1}-216_{2YM}). The HSs 215 each may include one or more CPUs configured to support the VMs 216 hosted by the HSs 215, respectively. The VMs 216 are configured to support TCP connections to CDs 230, via which CDs 230 may access and use VMs 216 for various functions. The DCN 210 may include various other resources configured to support communications associated with VMs 216 (e.g., processing resources, memory resources, storage resources, communication resources (e.g., switches, routers, communication links, or the like), or the like, as well as various combinations thereof). The typical configuration and operation of routers, ToR switches, SRs, HSs, VMs, and other elements in a DCN (e.g., ERs 212, ToR switches 213, SRs 214, HSs 215, and VMs 216 of DCN 210) will be understood by one skilled in the art.

The DCN 110 also includes a hierarchical load balancing arrangement that is configured to support distributed multi-level load balancing of TCP connections of CDs 230 across the VMs 216 of DCN 210. The hierarchical local balancing arrangement includes (1) a first hierarchical level including two first-level load balancers (LBs) 217₁₋₁ and 217₁₋₂ (collectively, first-level LBs 217₁) and (2) a second hierarchical level including two sets of second-level load balancers (LBs) 217₂₋₁ and 217₂₋₂ (collectively, second-level LBs 217₂).

The first hierarchical level is arranged such that the first-level LBs 217₁₁ and 217₁₂ are hosted on ToR switches 213₁ and 213₂, respectively. The ToR switches 213₁ and 213₂ are each connected to both SRs 214, such that each of the first-level LBs 217₁ is able to balance TCP connections across VMs 216 hosted on HSs 215 of both of the SRs 214 (i.e., for all VMs 216 of DCN 210). The operation of first-level LBs 217₁ in providing load balancing of TCP connections of the CDs 230 across VMs 216 is described in additional detail below.

The second hierarchical level is arranged such that the second-level LBs 217₂₋₁ and 217₂₋₂ are hosted on respective HSs 215 of SRs 214₁ and 214₂, respectively. In SR 214₁, HSs 215₁₁-215_{1X} include respective second-level LBs 217₂₋₁₁-217_{2-1X} configured to load balance TCP connections across the sets of VMs 216₁₁-216_{1X} of HSs 215₁₁-215_{1X}, respectively (illustratively, second-level LB 217₂₋₁₁ load balances TCP connections across VMs 216₁₁, and so forth, with second-level LB 217_{2-1X} load balancing TCP connections across VMs 216_{1X}). Similarly, in SR 214₂, HSs 215₂₁-215_{2Y} include respective second-level LBs 217₂₋₂₁-217_{2-2Y} configured to load balance TCP connections across the sets of VMs 216₂₁-216_{2Y} of HSs 215₂₁-215_{2Y}, respectively (illustratively, second-level LB 217₂₋₂₁ load balances TCP connections across VMs 216₂₁, and so forth, with second-level LB 217_{2-2Y} load balancing TCP connections across VMs 216_{2Y}). The operation of second-level LBs 217₂ in providing load balancing of TCP connections of the CDs 230 across VMs 216 is described in additional detail below.

More generally, given that the first hierarchical level is higher than the second hierarchical level in the hierarchical load balancing arrangement, it will be appreciated that the first hierarchical level supports load balancing of TCP connections across a set of VMs 216 and, further, that the second hierarchical level supports load balancing of TCP connections across respective subsets of VMs 216 of the set of VMs 216 for which the first hierarchical level supports load balancing of TCP connections.

The CN 220 includes any type of communication network(s) suitable for supporting communications between CDs 230 and DCN 210. For example, CN 220 may include wireline networks, wireless networks, or the like, as well as various combinations thereof. For example, CN 220 may include one or more wireline or wireless access networks, one or more wireless or wireless core networks, one or more public data networks, or the like.

The CDs 230 include devices configured to access and use resources of a data center network (illustratively, to access and use VMs 216 hosted by HSs 215 of DCN 210). For example, a CD 230 may be a thin client, a smart phone, a tablet computer, a laptop computer, a desktop computer, a television set-top-box, a media player, a server, a network device, or the like. The CDs 230 are configured to support TCP connections to VMs 216 of DCN 210.

The DCN 210 is configured to support a multi-level stateless load balancing capability for TCP connections between CDs 230 and VMs 216 of DCN 210. The support of the multi-level stateless load balancing capability for TCP connections between CDs 230 and VMs 216 of DCN 210 includes routing of TCP packets associated with the TCP connections, which includes TCP SYN packets and TCP non-SYN packets.

The ERs 212 are configured to receive TCP packets from CDs 230 via CN 220. The ERs 213 each support communication paths to each of the ToR switches 213. The ERs 212 each may be configured to support equal-cost communication paths to each of the ToR switches 213. An ER 212, upon receiving a TCP packet, routes the TCP packet to an appropriate one of the ToR switches 213 (e.g., for a TCP SYN packet this may be either of the ToR switches 213, whereas for a TCP non-SYN packet this is expected to be the ToR switch 213 associated with one of the HSs 215 hosting one of the VMs 216 of the TCP connection on which the TCP non-SYN packet is received). The ERs 212 may determine routing of TCP packets to the ToR switches 213 in any suitable manner. For example, an ER 212 may determine routing of a received TCP packet to an appropriate one of the ToR switches 213 by applying a hash algorithm to the TCP packet in order to determine the next hop for the TCP packet. The ERs 212 each may be configured to support routing of TCP packets to ToR switches 213 using equal-cost, multi-hop routing capabilities (e.g., based on one or more of RFC 2991, RFC 2992, or the like, as well as various combinations thereof).

The ToR switches 213 are configured to receive TCP packets from the ERs 212. The first-level LBs 217₁ of the ToR switches 213 are configured to perform load balancing of TCP connections across VMs 216 hosted by HSs 215 in the SRs 214 associated with the ToR switches 213, respectively.

For a TCP SYN packet received at a ToR switch 213, the first-level LB 217₁ of the ToR switch 213 selects one of the HSs 215 of the SR 214 with which the ToR switch 213 is associated (illustratively, first-level LB 217₁₁ of ToR switch 213₁ selects one of the HSs 215₁ associated with SR 214₁ and first-level LB 217₁₂ of ToR switch 213₂ selects one of the HSs 215₂ associated with SR 214₂). The first-level LB 217₁ of the ToR switch 213 may select one of the HSs 215 using a load balancing operation as discussed herein with respect to FIG. 1 (e.g., a round-robin based selection scheme, based on status information associated with HSs 215 of the SR 214, or the like). It will be appreciated that selection of one of the HSs 215 of the SR 214 with which the ToR switch 213 is associated also may be considered to be a selection of one of the second-level LBs 217₂ of the HSs 215 of the SR 214 with which the ToR switch 213 is associated. The ToR switch 213 propagates the TCP SYN packet to the selected one of the HSs 215 of the SR 214 with which the ToR switch 213 is associated.

For a TCP non-SYN packet received at a ToR switch 213, the first-level LB 217₁ of the ToR switch 213 may forward the TCP non-SYN packet to one of the second-level LBs 217₂ associated with one of the HSs 215 hosting one of the VMs 216 with which the associated TCP connection is established or may forward the TCP non-SYN packet to one of the VMs 216 with which the associated TCP connection is established without the TCP non-SYN packet passing through the one of the second-level LBs 217₂ associated with one of the HSs 215 hosting one of the VMs 216 with which the associated TCP connection is established. In either case, this ensures that the TCP non-SYN packets of an established TCP connection are routed to the VM 216 with which the TCP connection is established. The first-level LB 217₁ of the ToR switch 213 may forward the TCP non-SYN packet to the appropriate second-level LBs 217₂ using routing information embedded in the TCP non-SYN packet (discussed in additional detail below), using a hashing algorithm (e.g., a hashing algorithm similar to the hashing algorithm described with respect to the ERs 212), or the like. In the case of use of a hashing algorithm, the hashing algorithm may be modulo the number of active HSs 215 in the SR 214 associated with the ToR switch 213 that hosts the first-level LB 217₁.

The HSs 215 of an SR 214 are configured to receive TCP packets from the ToR switch 213 associated with the SR 214. The second-level LBs 217₂ of the HSs 215 are configured to perform load balancing of TCP connections across VMs 216 hosted by the HSs 215, respectively.

For a TCP SYN packet received at an HS 215 of an SR 214, the second-level LB 217₂ of the HS 215 selects one of the VMs 216 of the HS 215 as the VM 216 that will support the TCP connection to be established based on the TCP SYN packet. For example, for a TCP SYN packet received at HS 215₁₁ of SR 214₁ from ToR switch 213₁, second-level LB 217₂₋₁₁ of HS 215₁₁ selects one of the VMs 216₁₁ to support the TCP connection to be established based on the TCP SYN packet. Similarly, for example, for a TCP SYN packet received at HS 215_{2Y} of SR 214₂ from ToR switch 213₂, second-level LB 217_{2-2Y} of HS 215_{2Y} selects one of the VMs 216_{2Y} to support the TCP connection to be established based on the TCP SYN packet. The second-level LB 217₂ of the HS 215 may select one of the VMs 216 of the HS 215 using a load balancing operation as discussed herein with respect to FIG. 1 (e.g., a round-robin based selection scheme, based on status information associated with the VMs 216 or the HS 215, or the like). The HS 215 propagates the TCP SYN packet to the selected one of the VMs 216 of the HS 215.

For a TCP non-SYN packet received at an HS 215 of an SR 214, the second-level LB 217₂ of the HS 215 forwards the TCP non-SYN packet to one of the VMs 216 of the HS 215 with which the associated TCP connection is established. This ensures that the TCP non-SYN packets of an established TCP connection are routed to the VM 216 with which the TCP connection is established. The second-level LB 217₂ of the HS 215 may forward the TCP non-SYN packet to the appropriate VM 216 using routing information in the TCP non-SYN packet (discussed in additional detail below), using a hashing algorithm (e.g., a hashing algorithm similar to the hashing algorithm described with respect to the ERs 212), or the like. In the case of use of a hashing algorithm, the hashing algorithm may be modulo the number of active VMs 216 in the HS 215 hosts the second-level LB 217₂.

In at least some embodiments, routing of TCP packets between CDs 230 and VMs 216 via may be performed using routing information that is configured on the routing elements, routing information determined by the routing elements from TCP packets traversing the routing elements (e.g., based on insertion of labels, addresses, or other suitable routing information), or the like, as well as various combinations thereof. In such embodiments, the routing elements may include LBs 217 and VMs 216. In such embodiments, the routing information may include any suitable address or addresses for routing TCP packets between elements.

In the downstream direction from CDs 230 toward VMs 216, TCP packets may be routed based on load-balancing operations as discussed above as well as based on routing information, which may depend on the type of TCP packet being routed (e.g., routing TCP SYN packets based on load balancing operations, routing TCP ACK packets and other TCP non-SYN packets based on routing information, or the like).

In the upstream direction from VMs 216 toward CDs 230, the TCP packets may be routed toward the CDs 230 via the LB(s) 217 used to route TCP packets in the downstream direction or independent of the LB(s) 217 used to route TCP packets in the downstream direction. For example, for a TCP packet sent from a VM 216_{1X1} toward CD 230₁ (where the associated TCP SYN packet traversed a path via first-level LB 217₁₋₁ and second-level LB 217_{2-1X}), the TCP packet may be sent via second-level LB 217_{2-1X} and first-level LB 217₁₋₁, via second-level LB 217_{2-1X} only, via first-level LB 217₁₋₁ only, or independent of either second-level LB 217_{2-1X} and first-level LB 217₁₋₁. In the case of a one-to-one relationship between an element at a first hierarchical level (an LB 217) and an element at a second hierarchical level (an LB 217 or a VM 216), for example, the element at the second hierarchical level may be configured with a single upstream address of the element at the first hierarchical level such that the element at the first hierarchical level does not need to insert into downstream packets information for use by the element at the second hierarchical level to route corresponding upstream packets back to the element at the first hierarchical level. In the case of a many-to-one relationship between multiple elements at a first hierarchical level (e.g., LBs 217) and an element at a second hierarchical level (an LB 217 or a VM 216), for example, the element at the second hierarchical level may be configured to determine routing of TCP packets in the upstream direction based on routing information inserted into downstream TCP packets by the elements at the first hierarchical level. It will be appreciated that these techniques also may be applied in other ways (e.g., in the case of a one-to-one relationship between an element at a first hierarchical level and an element at a second hierarchical level, the element at the second hierarchical level may perform upstream routing of TCP packets using routing information inserted into downstream TCP packets by the element at the first hierarchical level; in the case of a many-to-one relationship between multiple elements at a first hierarchical level and an element at a second hierarchical level, the element at the second hierarchical level may perform upstream routing of TCP packets using routing information configured on the element at the second hierarchical level (e.g., upstream addresses of the respective elements at the first hierarchical level); and so forth).

In at least some embodiments, in which labels used by the LBs 217 are four bits and forged MAC addresses are used for L2 forwarding between the elements, routing of TCP packets for a TCP connection between a CD 230 and a VM 216 may be performed as follows. In the downstream direction, a first LB 217 (illustratively, a first-level LB 217₁) receiving a TCP SYN packet from the CD 230 might insert a label of 0xA into the TCP SYN packet and forward the TCP SYN packet to a second LB 217 with a destination MAC address of 00:00:00:00:00:0A (illustratively, a second-level LB 217₂), and the second LB 217 receiving the TCP SYN packet from the first LB 217 might insert a label of 0xB into the TCP SYN packet and forward the TCP packet to a server with a destination MAC address of 00:00:00:00:00:B0 (illustratively, an HS 215 hosting the VM 216), In the upstream direction, the VM 216 would respond to the TCP SYN packet by sending an associated TCP SYN+ACK packet intended from the CD 230. The TCP SYN+ACK packet may (1) include each of the labels inserted into the TCP SYN packet (namely, 0xA and 0xB) or (2) may include only the last label inserted into the TCP SYN packet (namely, the label 0xB associated with the LB 217 serving the VM 216). It is noted that the TCP SYN+ACK packet may include only the last label inserted into the TCP SYN packet where the various elements are on different subnets or under any other suitable configurations or conditions. In either case, the TCP SYN+ACK packet is routed back to the CD 230, and the CD 230 responds by sending a TCP ACK packet intended for delivery to the VM 216 which processed the corresponding TCP SYN packet. For the case in which the VM 216 sends the TCP SYN+ACK packet such that it includes each of the labels inserted into the TCP SYN packet, the CD 230 will insert each of the labels into the TCP ACK packet such that the TCP ACK packet traverses the same path traversed by the corresponding TCP SYN packet (namely, the first LB 217 would use label 0xA to forward the TCP ACK packet to the second LB 217 having MAC address 00:00:00:00:00:0A and the second LB 217 would use label 0xB to forward the TCP ACK packet to the server having MAC address 00:00:00:00:00:0B (which is hosting the VM 216)). Alternatively, for the case in which the VM 216 sends the TCP SYN+ACK packet such that it includes only the last label inserted into the TCP SYN packet (namely, the 0xB label associated with the server hosting the VM 216), the CD 230 will insert the 0xB label into the TCP ACK packet, and the first LB 217, upon receiving the TCP ACK packet including only the 0xB label, will forward the TCP ACK packet to the server having MAC address 00:00:00:00:00:0B (which is hosting the VM 216) that is associated with the 0xB label directly such that the TCP ACK packet does not traverse the first LB 217. It will be appreciated that, although primarily described with respect to specific types of routing information (namely, 4-bit labels and MAC addresses), any other suitable routing information may be used (e.g., labels having other numbers of bits, routing information other than labels, other types of addresses, or the like, as well as various combinations thereof). In other words, in at least some such embodiments, the routing information may include any information suitable for routing TCP packets between elements. Thus, it will be appreciated that, in at least some embodiments, an LB 217 receiving a TCP SYN packet associated with a TCP connection to be established between a CD 230 and a VM 216 may need to insert into the TCP SYN packet some information adapted to enable the elements receiving the TCP SYN packet and other TCP packets associated with the TCP connection to route the TCP packets between the CD 230 and the VM 216.

In at least some embodiments, for a TCP SYN packet that is sent from a CD 230 to a VM 216, the corresponding TCP SYN+ACK packet that is sent from the VM 216 back to the CD 230 may be routed via the sequence of LBs 217 used to route the TCP SYN packet. In at least some embodiments, the TCP SYN+ACK packet that is sent by the VM 216 back to the CD 230 may include status information associated with the VM 216 (e.g., current load on the VM 216, current available processing capacity of the VM 216, or the like, as well as various combinations thereof. In at least some embodiments, as TCP SYN+ACK packets are routed from VMs 216 back toward CDs 230, LBs 217 receiving the TCP SYN+ACK packets may aggregate status information received in TCP SYN+ACK packets from VMs 216 in the sets of VMs 216 served by those LBs 217, respectively. In this manner, a LB 217 may get an aggregate view of the status of each of the elements in the set of elements at the next lowest level of the hierarchy from the LB 217, such that the LB 217 may perform selection of elements for TCP SYN packets based on the aggregate status information for the elements available for selection by the LB 217. For example, as second-level LB 217₂₋₁₁ receives TCP SYN+ACK packets from VMs 216₁₁₁-216_{11A}, second-level LB 217₂₋₁₁ maintains aggregate status information for each of the VMs 216₁₁₁-216_{11A}, respectively, and may use the aggregate status information for each of the VMs 216₁₁₁-216_{11A} to select between the VMs 216₁₁₁-216_{11A} for handling of subsequent TCP SYN packets routed to second-level LB 217₂₋₁₁ by first-level LB 217₁₋₁. Similarly, for example, as first-level LB 217₁₋₁ receives TCP SYN+ACK packets from second-level LBs 217₂₋₁₁-217_{2-1X}, first-level LB 217₁₋₁ maintains aggregate status information for each of the second-level LBs 217₂₋₁₁-217_{2-1X} (which corresponds to aggregation of status information for the respective sets of VMs 216₁₁-216_{1X} served by second-level LBs 217₂₋₁₁-217_{2-1X}, respectively), respectively, and may use the aggregate status information for each of the second-level LBs 217₂₋₁₁-217_{2-1X} to select between the second-level LBs 217₂₋₁₁-217_{2-1X} for handling of subsequent TCP SYN packets routed to first-level LB 217₁₋₁ by one or both of the ERs 212.

It will be appreciated that, although primarily depicted and described herein with respect to an exemplary communication system including specific types, numbers, and arrangements of elements, various embodiments of the distributed multi-level stateless load balancing capability may be provided within a communication system including any other suitable types, numbers, or arrangements of elements. For example, although primarily depicted and described with respect to a single datacenter, it will be appreciated that various embodiments of the distributed multi-level stateless load balancing capability may be provided within a communication system including multiple datacenters. For example, although primarily depicted and described with respect to specific types, numbers, and arrangements of physical elements (e.g., ERs 211, ToR switches 212, SRs 214, HSs 215, and the like), it will be appreciated that various embodiments of the distributed multi-level stateless load balancing capability may be provided within a communication system including any other suitable types, numbers, or arrangements of physical elements. For example, although primarily depicted and described with respect to specific types, numbers, and arrangements of virtual elements (e.g., VMs 216), it will be appreciated that various embodiments of the distributed multi-level stateless load balancing capability may be provided within a communication system including any other suitable types, numbers, or arrangements of virtual elements.

It will be appreciated that, although primarily depicted and described herein with respect to an exemplary communication system supporting a specific number and arrangement of hierarchical levels for stateless load balancing of TCP connections, a communication system supporting stateless load balancing of TCP connections may support any other suitable number or arrangement of hierarchical levels for stateless load balancing of TCP connections. For example, although primarily depicted and described with respect to two hierarchical levels (namely, a higher or highest level and a lower or lowest level), one or more additional, intermediate hierarchical levels may be used for stateless load balancing of TCP connections. For example, for a communication system including one datacenter, three hierarchical levels of stateless load balancing may be provided as follows: (1) a first load balancer may be provided at a router configured to operate as an interface between the elements of the data center and the communication network supporting communications for the data center, (2) a plurality of second sets of load balancers may be provided at the respective ToR switches of the data center to enable load balancing between host servers supported by the ToR switches in a second load balancing operation, and (3) a plurality of third sets of load balancers may be provided at the host servers associated with the respective ToR switches of the data center to enable load balancing between VMs hosts by the host servers associated with the respective ToR switches in a third load balancing operation. For example, for a communication system including multiple datacenters, three hierarchical levels of stateless load balancing may be provided as follows: (1) a first load balancer may be provided within a communication network supporting communications with the datacenters to enable load balancing between the data centers in a first load balancing operation, (2) a plurality of second sets of load balancers may be provided at the ToR switches of the respective data centers to enable load balancing between host servers supported by the ToR switches in a second load balancing operation, and (3) a plurality of third sets of load balancers may be provided at the host servers associated with the respective ToR switches of the respective data centers to enable load balancing between VMs hosts by the host servers associated with the respective ToR switches in a third load balancing operation. Various other numbers or arrangements of hierarchical levels for stateless load balancing of TCP connections are contemplated.

In at least some embodiments, associations between a load balancer of a first hierarchical level and elements of a next hierarchical level that are served by the load balancer of the first hierarchical level (e.g., load balancers or VMs, depending on the location of the first hierarchical level within the hierarchy of load balancers) may be set based on a characteristic or characteristics of the elements of the next hierarchical level (e.g., respective load factors associated with the elements of the next hierarchical level). In at least some embodiments, for example, the load balancer of the first hierarchical level may query a Domain Name Server (DNS) for a given hostname to obtain the IP addresses and load factors of each of the elements of the next hierarchical level across which the load balancer of the first hierarchical level distributes TCP SYN packets. The load balancer of the first hierarchical level may query a DNS using DNS SRV queries as described in RFC2782, or in any other suitable manner. The elements of the next hierarchical level that are served by the load balancer of the first hierarchical level may register with the DNS so that the DNS has the information needed to service queries from the load balancer of the first hierarchical level. In at least some embodiments, in which the elements of the next hierarchical level that are served by the load balancer of the first hierarchical level are VMs (e.g., VMs used to implement load balancers or VMs processing TCP SYN packets for establishment of TCP connections), the VMs may dynamically register themselves in the DNS upon startup and may unregister upon shutdown. For example, at least some cloud platforms (e.g., OpenStack) have built-in support for DNS registration. The DNS queries discussed above may be used to initially set the associations, to reevaluate and dynamically modify the associations (e.g., periodically, in response to a trigger condition, or the like), or the like, as well as various combinations thereof. It will be appreciated that, although depicted and described with respect to use of DNS queries, any other types of queries suitable for use in obtaining such information may be used.

In at least some embodiments, for TCP SYN packets, load balancers at one or more of the hierarchical levels of load balancers may perform VM load-balancing selections for TCP SYN packets using broadcast capabilities, multicast capabilities, serial unicast capabilities, or the like, as well as various combinations thereof.

In at least some embodiments, for TCP SYN packets, the lowest level of load balancers which perform VM load-balancing selections for TCP SYN packets (illustratively, second-level LBs 217₂ in DCN 210 of FIG. 2) may use broadcast capabilities to forward each TCP SYN packet. For example, one of the second-level LBs 217₂ that receives a TSP SYN packet may forward the received TCP SYN packet to each of the VMs 216 for which the one of the second-level LBs 217₂ performs load balancing of TCP SYN packets. The broadcasting of a TCP SYN packet may be performed using a broadcast address (e.g., 0xff:0xff:0xff:0xff:0xff:0xff, or any other suitable address). The replication of a TCP SYN packet to be broadcast in this manner may be performed in any suitable manner.

In at least some embodiments, for TCP SYN packets, the lowest level of load balancers which perform VM load-balancing selections for TCP SYN packets (illustratively, second-level LBs 217₂ in DCN 210 of FIG. 2) may use multicast capabilities to forward each TCP SYN packet. For example, one of the second-level LBs 217₂ that receives a TSP SYN packet may forward the received TCP SYN packet to a multicast distribution group that includes a subset of the VMs 216 for which the one of the second-level LBs 217₂ performs load balancing of TCP SYN packets. The multicast of a TCP SYN packet may be performed using a forged multicast address (e.g., 0x0F:0x01:0x02:0x03:0x04:n for multicast group <n>, or any other suitable address). For this purpose, for a given one of the second-level LBs 217₂, (1) the set of VMs 216 for which the one of the second-level LBs 217₂ performs load balancing of TCP SYN packets may be divided into multiple multicast (distribution) groups having forged multicast addresses associated therewith, respectively, and (2) for each of the VMs 216 for which the one of the second-level LBs 217₂ performs load balancing of TCP SYN packets, the VM 216 may be configured to accept TCP SYN packets on the target multicast address of the multicast group to which the VM 216 is assigned. The replication of a TCP SYN packet to be multicast in this manner may be performed in any suitable manner. It will be appreciated that use of multicast, rather than broadcast, to distribute a TCP SYN packet to multiple VMs 216 may reduce overhead (e.g., processing and bandwidth overhead) while still enabling automatic selection of the fastest one of the multiple VMs 216 to handle the TCP SYN packet and the associated TCP connection that is established responsive to the TCP SYN packet (since, at most, only <v> VMs 216 will respond to any given TCP SYN packet where <v> is the number of VMs 216 in the multicast group).

In at least some embodiments, for TCP SYN packets, the lowest level of load balancers which perform VM load-balancing selections for TCP SYN packets (illustratively, second-level LBs 217₂ in DCN 210 of FIG. 2) may use serial unicast capabilities to forward each TCP SYN packet. For example, one of the second-level LBs 217₂ that receives a TSP SYN packet may forward the received TCP SYN packet to one or more VMs 216 in a set of VMs 216 (where the set of VMs 216 may include some or all of the VMs 216 for which the one of the second-level LBs 217₂ performs load balancing of TCP SYN packets) serially until receiving a successful response from one of the VMs 216.

It will be appreciated that, although multicast and broadcast capabilities are not typically used in TCP applications, use of multicasting or broadcasting of TCP SYN packets to multiple VMs 216 as described above enables automatic selection of the fastest one of the multiple VMs 216 to respond to the TCP SYN packet (e.g., later response by other VMs 216 to which the TCP SYN packet is multicasted or broadcasted will have different TCP sequence numbers (SNs) and, thus, typically will receive reset (RST) packets from the CD 230 from which the associated TCP SYN packet was received).

In at least some embodiments, for TCP SYN packets, any level of load balancers other than the lowest level of load balancers (illustratively, first-level LBs 217₁ in DCN 210 of FIG. 2) may use may use broadcast capabilities or multicast capabilities to forward each TCP SYN packet. These load balancers may use broadcast capabilities or multicast capabilities as described above for the lowest level of load balancers. For example, one of the first-level LBs 217₁ that receives a TSP SYN packet may forward the received TCP SYN packet to a distribution group that includes all (e.g., broadcast) or a subset (e.g., multicast) of the second-level load balancers 217₂ for which the one of the first-level LBs 217₁ performs load balancing of TCP SYN packets. In at least some embodiments, the next (lower) level of load balancers may be configured to perform additional filtering adapted to reduce the number of load balancers at the next hierarchical level of load balancers that respond to a broadcasted or multicasted TCP SYN packet. In at least some embodiments, when one of the first-level LBs 217₁ forwards a TCP SYN packet to a distribution group of second-level load balancers 217₂, the second-level load balancers 217₂ of the distribution group may be configured to perform respective calculations such that the second-level load balancers 217₂ can determine, independently of each other, which of the second-level load balancers 217₂ of the distribution group is to perform further load balancing of the TCP SYN packet. For example, when one of the first-level LBs 217₁ forwards a TCP SYN packet to a distribution group of second-level load balancers 217₂, the second-level load balancers 217₂ of the distribution group may have synchronized clocks and may be configured to (1) perform the following calculation when the TCP SYN packet is received: <current time in seconds>%<number of second-level load balancers 217₂ in the distribution group> (where ‘%’ denotes modulo), and (2) forward the TCP SYN packet based on a determination that the result of the calculation corresponds to a unique identifier of that second-level load balancers 217₂, otherwise drop the TCP SYN packet. This example has the effect of distributing new TCP connections to a different load balancer every second. It will be appreciated that such embodiments may use a time scale other than seconds in the calculation. It will be appreciated that such embodiments may use other types of information (e.g., other than or in addition to temporal information) in the calculation. It will be appreciated that, in at least some embodiments, multiple load balancers of the distribution group may be assigned the same unique identifier, thereby leading to multiple responses to the TCP SYN packet (e.g., where the fastest response to the TCP SYN packet received at that level of load balancers is used and any other later responses to the TCP SYN packet are dropped). It will be appreciated that failure of such embodiments to result in establishment of a TCP connection responsive to the TCP SYN packet (e.g., where the additional filtering capability does not result in further load balancing of the TCP SYN packet at the next hierarchical level of load balancers, such as due to variations in timing, queuing, synchronization, or the like) may be handled by the retransmission characteristics of the TCP client (illustratively, one of the CDs 230) from which the TCP SYN packet was received (e.g., the TCP client will retransmit the TCP SYN packet one or more times so that the TCP client gets one or more additional chances to establish the TCP connection before the TCP connection fails).

In at least some embodiments, a given load balancer at one or more of the hierarchical levels of load balancers may be configured to automatically discover the set of load balancers at the next lowest level of the hierarchical levels of load balancers (i.e., adjacent load balancers in the direction toward the processing elements). In at least some embodiments, a given load balancer at one or more of the hierarchical levels of load balancers may be configured to automatically discover the set of load balancers at the next lowest level of the hierarchical levels of load balancers by issuing a broadcast packet configured such that only load balancers at the next lowest level of the hierarchical levels of load balancers (and not any load balancers further downstream or the processing elements) respond to the broadcast packet. The broadcast packet may be configured to a flag that is set in the packet or in any other suitable manner. The broadcast packet may be a TCP broadcast probe or any other suitable type of packet or probe.

In at least some embodiments, a given load balancer at one or more of the hierarchical levels of load balancers may be configured to dynamically control the set of processing elements (illustratively, VMs 216) for which the given load balancer performs load balancing of TCP connections. In at least some embodiments, when a TCP SYN packet for a given TCP client is routed from a given load balancer (which may be at any level of the hierarchy of load balancers) to a particular processing element, the corresponding TCP SYN+ACK packet that is sent by that processing element may be routed to that given load balancer (namely, to the originating load balancer of the TCP SYN packet). It will be appreciated that this routing might be similar, for example, to an IP source routing option. It will be appreciated that, in the case of one or more hierarchical levels between the given load balancers and the set of processing elements, a stack of multiple addresses (e.g., IP addresses or other suitable addresses) may be specified within the TCP SYN packet for use in routing the associated TCP SYN+ACK packet from the processing element back to the given load balancer. The TCP SYN+ACK packet received from the processing element may include status information associated with the processing element or the host server hosting the processing element (e.g., the VM 216 that responded with the TCP SYN+ACK packet or the HS 215 which hosts the VM 216 which responded with the TCP SYN+ACK packet) that is adapted for use by the given load balancer in determining whether to dynamically modify the set of processing elements across which the given load balancer performs load balancing of TCP connections. For example, the status information may include one or more of an amount of free memory, a number of sockets in use, CPU load, a timestamp for use in measuring round trip time (RTT), of the like, as well as various combinations thereof. The given load balancer may use the status information to determine whether to modify the set of processing elements for which the given load balancer performs load balancing of TCP connections. For example, based on status information associated with an HS 215 that is hosting VMs 216, the given load balancer may initiate termination of one or more existing VMs 216, initiate instantiation of one or more new VMs 216, or the like. In at least some embodiments, the given load balancer may use the number of open sockets associated with a processing element in order to terminate the processing element without breaking any existing TCP connections, as follows: (1) the given load balancer module would stop forwarding new TCP SYN packets to the processing element, (2) the given load balancer would then monitor the number of open sockets of the processing element in order to determine when the processing element becomes idle (e.g., based on a determination that the number of sockets reaches zero, or reaches the number of sockets open at the time at which the given load balancer began distributing TCP SYN packets to the processing element), and (3) the given load balancer would then terminate the processing element based on a determination that the processing element is idle. The given load balancer may control removal or addition of VMs 216 directly (e.g., through an OpenStack API) or indirectly (e.g., sending a message to a management system configured to control removal or addition of VMs 216). As discussed above, in at least some embodiments the given load balancer may use the status information in performing load balancing of TCP SYN packets received at the given load balancer.

In at least some embodiments, for TCP non-SYN packets, the TCP non-SYN packet may be forwarded at any given hierarchical level based on construction of a destination address (e.g., destination MAC address) including an embedded label indicative of the given hierarchical level. This ensures that the TCP non-SYN packets of an established TCP connection are routed between the client and the server between which the TCP connection is established.

It will be appreciated that, although primarily depicted and described within the context of embodiments in which distributed multi-level stateless load balancing is implemented for performing distributed multi-level stateless load balancing for a specific stateful-connection protocol (namely, TCP), various embodiments of the distributed multi-level stateless load balancing capability may be adapted to perform distributed multi-level stateless load balancing for various other types of stateful-connection protocols (e.g., Stream Control Transmission Protocol (SCTP), Reliable User Datagram Protocol (RUDP), or the like. Accordingly, references herein to TCP may be read more generally as a stateful-connection protocol or a stateful protocol), references herein to TCP SYN packets may be read more generally as initial connection packets (e.g., where an initial connection packet is a first packet sent by a client to request establishment of a connection), references herein to TCP SYN+ACK packets may be read more generally as initial connection response packets (e.g., where an initial connection response packet is response packet sent to a client responsive to receive of an initial connection packet), and so forth.

It will be appreciated that, although primarily depicted and described within the context of embodiments in which distributed multi-level stateless load balancing is implemented within specific types of communication systems (e.g., within a datacenter-based environment), various embodiments of the distributed multi-level stateless load balancing capability may be provided in various other types of communication systems. For example, various embodiments of the distributed multi-level stateless load balancing capability may be adapted to provide distributed multi-level stateless load balancing within overlay networks, physical networks, or the like, as well as various combinations thereof. For example, various embodiments of the distributed multi-level stateless load balancing capability may be adapted to provide distributed multi-level stateless load balancing for tunneled traffic, traffic of Virtual Local Area Networks (VLANs), traffic of Virtual Extensible Local Area Networks (VXLANs), traffic using Generic Routing Encapsulation (GRE), IP-in-IP tunnels, or the like, as well as various combinations thereof. For example, various embodiments of the distributed multi-level stateless load balancing capability may be adapted to provide distributed multi-level stateless load balancing across combinations of virtual processing elements (e.g., VMs) and physical processing elements (e.g., processors of a server, processing cores of a processor, or the like), across only physical processing elements, or the like. Accordingly, references herein to specific types of devices of a datacenter (e.g., ToR switches, host servers, and so forth) may be read more generally (e.g., as network devices, servers, and so forth), references herein to VMs may be read more generally as virtual processing elements or processing elements, and so forth.

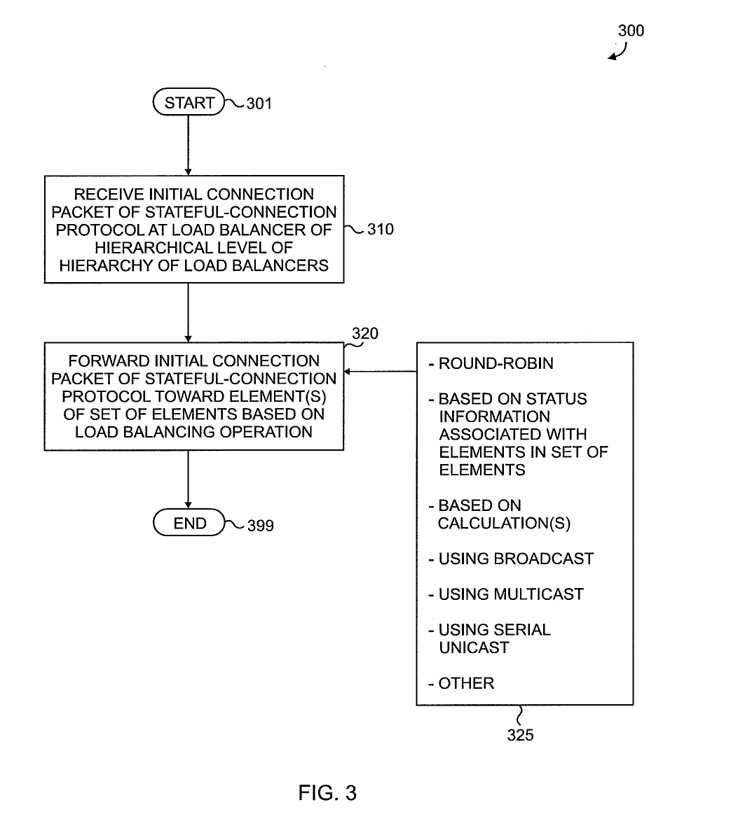

In view of the broader applicability of embodiments of the distributed multi-level stateless load balancing capability, a more general method that covers broader applicability of embodiments of the distributed multi-level stateless load balancing capability is depicted and described in FIG. 3.

FIG. 3 depicts an embodiment of a method for performing a load balancing operation for an initial connection packet of a stateful-connection protocol. It will be appreciated that, although primarily depicted and described herein as being performed serially, at least a portion of the steps of method 300 of FIG. 3 may be performed contemporaneously or in a different order than depicted in FIG. 3.

At step 301, method 300 begins.

At step 310, an initial connection packet of a stateful-connection protocol is received at a load balancer of a given hierarchical level of a hierarchy of load balancers. The given hierarchical level may be at any level of the hierarchy of load balancers. The load balancer of the given hierarchical level in configured to perform load balancing across a set of processing elements configured to process the initial connection packet of the stateful-connection protocol for establishing a connection in accordance with the stateful-connection protocol. For example, the set of processing elements may include one or more virtual processing elements (e.g., VMs), one or more physical processing elements (e.g., processors on a server(s)), or the like, as well as various combinations thereof.

At step 320, the load balancer of the hierarchical level forwards the initial connection packet of the stateful-connection protocol toward an element or elements of a set of elements based on a load balancing operation.

The set of elements may include (1) a set of load balancers of a next hierarchical level of the hierarchy of load balancers (the next hierarchical being lower than, or closer to the processing elements, than the given hierarchical level) where the load balancer of the next hierarchal level is configured to perform load balancing across a subset of processing elements from the set of processing elements across which the load balancer of the given hierarchical level is configured to perform load balancing or (2) one of the processing elements across which the load balancer of the given hierarchical level is configured to perform load balancing.

The load balancing operation, as depicted in box 325, may include one or more of round-robin selection of the one of the elements of the set of elements, selection of one of the elements of the set of elements based on status information associated with the elements of the set of elements (e.g., aggregated status information determined based on status information received in initial connection response packets sent by the elements responsive to receipt of corresponding initial connection packets), selection of one of the elements of the set of elements based on a calculation (e.g., <current time in seconds> modulo <the number of elements in the set of elements>, or any other suitable calculation), propagation of the initial connection packet of the stateful-connection protocol toward each of the elements of the set of elements based on a broadcast capability, propagation of the initial connection packet of the stateful-connection protocol toward a subset of the elements of the set of elements based on a multicast capability, propagation of the initial connection packet of the stateful-connection protocol toward one or more of the elements of the set of elements based on a serial unicast capability, or the like, as well as various combinations thereof.

At step 399, method 300 ends.

It will be appreciated that, although primarily depicted and described within the context of embodiments in which distributed multi-level stateless load balancing is implemented for performing distributed multi-level stateless load balancing for stateful-connection protocols, various embodiments of the distributed multi-level stateless load balancing capability may be adapted to perform distributed multi-level stateless load balancing for stateless protocols (e.g., User Datagram Protocol (UDP) or the like). It will be appreciated that, in the case of such stateless protocols, the considerations or benefits of the stateless operation of the distributed multi-level stateless load balancing capability may not apply as the protocols themselves are already stateless.

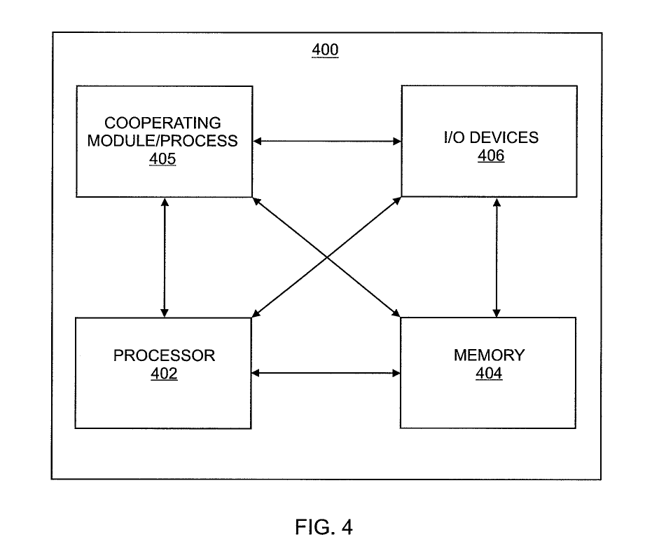

FIG. 4 depicts a high-level block diagram of a computer suitable for use in performing functions described herein.

The computer 400 includes a processor 402 (e.g., a central processing unit (CPU) and/or other suitable processor(s)) and a memory 404 (e.g., random access memory (RAM), read only memory (ROM), and the like).

The computer 400 also may include a cooperating module/process 405. The cooperating process 405 can be loaded into memory 404 and executed by the processor 402 to implement functions as discussed herein and, thus, cooperating process 405 (including associated data structures) can be stored on a computer readable storage medium, e.g., RAM memory, magnetic or optical drive or diskette, and the like.

The computer 400 also may include one or more input/output devices 406 (e.g., a user input device (such as a keyboard, a keypad, a mouse, and the like), a user output device (such as a display, a speaker, and the like), an input port, an output port, a receiver, a transmitter, one or more storage devices (e.g., a tape drive, a floppy drive, a hard disk drive, a compact disk drive, and the like), or the like, as well as various combinations thereof).

It will be appreciated that computer 500 depicted in FIG. 4 provides a general architecture and functionality suitable for implementing functional elements described herein and/or portions of functional elements described herein. For example, computer 400 provides a general architecture and functionality suitable for implementing one or more of an HS 112, LB 115, an element of CN 120, a CD 130, an HS 215, a ToR switch 213, an ER 212, a load balancer 217, an element of CN 220, a CD 230, or the like.

It will be appreciated that the functions depicted and described herein may be implemented in software (e.g., via implementation of software on one or more processors, for executing on a general purpose computer (e.g., via execution by one or more processors) so as to implement a special purpose computer, and the like) and/or may be implemented in hardware (e.g., using a general purpose computer, one or more application specific integrated circuits (ASIC), and/or any other hardware equivalents).

It will be appreciated that some of the steps discussed herein as software methods may be implemented within hardware, for example, as circuitry that cooperates with the processor to perform various method steps. Portions of the functions/elements described herein may be implemented as a computer program product wherein computer instructions, when processed by a computer, adapt the operation of the computer such that the methods and/or techniques described herein are invoked or otherwise provided. Instructions for invoking the inventive methods may be stored in fixed or removable media, transmitted via a data stream in a broadcast or other signal bearing medium, and/or stored within a memory within a computing device operating according to the instructions.

It will be appreciated that the term “or” as used herein refers to a non-exclusive “or,” unless otherwise indicated (e.g., use of “or else” or “or in the alternative”).

It will be appreciated that, although various embodiments which incorporate the teachings presented herein have been shown and described in detail herein, those skilled in the art can readily devise many other varied embodiments that still incorporate these teachings.

What is claimed is:

1. An apparatus, comprising:
a processor and a memory communicatively connected to the processor, the processor configured to:
receive an initial connection packet of a stateful-connection protocol at a first load balancer configured to perform load balancing across a set of processing elements, the initial connection packet of the stateful-connection protocol configured to request establishment of a stateful connection; and
perform a load balancing operation at the first load balancer to control forwarding of the initial connection packet of the stateful-connection protocol toward a set of second load balancers configured to perform load balancing across respective subsets of processing elements of the set of processing elements.

2. The apparatus of claim 1, wherein, to perform the load balancing operation to control forwarding of the initial connection packet of the stateful-connection protocol toward the set of second load balancers, the processor is configured to:
select one of the second load balancers in the set of second load balancers; and
forward the initial connection packet toward the selected one of the second load balancers.

3. The apparatus of claim 2, wherein the processor is configured to select the one of the second load balancers based on at least one of a round-robin selection scheme, a calculation associated with the one of the second load balancers, or status information associated with the one of the second load balancers.

4. The apparatus of claim 2, wherein the processor is configured to:
prior to forwarding the initial connection packet toward the selected one of the second load balancers, modify the initial connection packet to include an identifier of the first load balancer.

5. The apparatus of claim 2, wherein the processor is configured to:
receive, from the selected second load balancer, an initial connection response packet generated by one of the processing elements based on the initial connection packet.

6. The apparatus of claim 5, wherein the initial connection packet is received from a client, wherein the processor is configured to:
propagate the initial connection response packet toward the client.

7. The apparatus of claim 5, wherein the initial connection response packet comprises an identifier of the one of the processing elements.

8. The apparatus of claim 7, wherein the initial connection packet is received from a client, wherein the processor is configured to:
receive, from the client, a subsequent packet of the stateful-connection protocol, the subsequent packet associated with a connection established between the client and the one of the processing elements based on the initial connection packet, wherein the subsequent packet comprises the identifier of the one of the processing elements; and
forward the subsequent packet toward the one of the processing elements, based on the identifier of the one of the processing elements, independent of the set of second load balancers.

9. The apparatus of claim 5, wherein the initial connection response packet comprises status information for the one of the processing elements.

10. The apparatus of claim 9, wherein the processor is configured to:
update aggregate status information for the selected second load balancer based on the status information for the one of the processing elements.

11. The apparatus of claim 1, wherein, to perform the load balancing operation to control forwarding of the initial connection packet of the stateful-connection protocol toward the set of second load balancers, the processor is configured to:
initiate a query to obtain a set of addresses of the respective second load balancers in the set of second load balancers and status information associated with the respective second load balancers in the set of second load balancers;
select one of the second load balancers in the set of second load balancers based on the status information associated with the second load balancers in the set of second load balancers; and
forward the initial connection packet of the stateful-connection protocol toward the selected one of the second load balancers based on the address of the selected one of the second load balancers.

12. The apparatus of claim 1, wherein, to perform the load balancing operation to control forwarding of the initial connection packet of the stateful-connection protocol toward the set of second load balancers, the processor is configured to:
broadcast the initial connection packet of the stateful-connection protocol toward each of the second load balancers in the set of second load balancers based on a broadcast address assigned for the second load balancers in the set of second load balancers.

13. The apparatus of claim 1, wherein, to perform the load balancing operation to control forwarding of the initial connection packet of the stateful-connection protocol toward the set of second load balancers, the processor is configured to:
multicast the initial connection packet of the stateful-connection protocol toward a multicast group including two or more of the second load balancers in the set of second load balancers based on a forged multicast address assigned for the second load balancers in the multicast group.

14. The apparatus of claim 1, wherein, to perform the load balancing operation to control forwarding of the initial connection packet of the stateful-connection protocol toward the set of second load balancers, the processor is configured to:
forward the initial connection packet of the stateful-connection protocol toward two or more of the second load balancers in the set of second load balancers;
receive two or more initial connection response packets of the stateful-connection protocol responsive to forwarding of the initial connection packet of the stateful-connection protocol toward the two or more of the second load balancers; and
forward one of the initial connection response packets that is received first without forwarding any other of the initial connection response packets.

15. The apparatus of claim 1, wherein, to perform the load balancing operation to control forwarding of the initial connection packet of the stateful-connection protocol toward the set of second load balancers, the processor is configured to:
forward the initial connection packet of the stateful-connection protocol toward a first one of the second load balancers in the set of second load balancers; and
forward the initial connection packet of the stateful-connection protocol toward a second one of the second load balancers in the set of second load balancers based on a determination that a successful response to the initial connection packet of the stateful-connection protocol is not received responsive to forwarding of the initial connection packet of the stateful-connection protocol toward the first one of the second load balancers in the set of second load balancers.

16. The apparatus of claim 1, wherein the processor is configured to:
determine, based on status information associated with at least one of the processing elements in the set of processing elements, whether to modify the set of processing elements.

17. The apparatus of claim 1, wherein the processor is configured to:
based on a determination to terminate a given processing element from the set of processing elements:
prevent forwarding of subsequent packets of the stateful-connection protocol toward the given processing element;
monitor a number of open sockets of the given processing element; and
initiate termination of the given processing element based on a determination that the number of open sockets of the given processing element is indicative that the given processing element is idle.

18. The apparatus of claim 1, wherein one of:
the first load balancer is associated with a network device of a communication network and the second load balancers are associated with respective elements of one or more datacenters;
the first load balancer is associated with a network device of a datacenter network and the second load balancers are associated with respective racks of the datacenter network;
the first load balancer is associated with a rack of a datacenter network and the second load balancers are associated with respective servers of the rack; or
the first load balancer is associated with a server of a datacenter network and the second load balancers are associated with respective processors of the server.

19. A method, comprising:
using a processor and a memory for:
receiving an initial connection packet of a stateful-connection protocol at a first load balancer configured to perform load balancing across a set of processing elements, the initial connection packet of the stateful-connection protocol configured to request establishment of a stateful connection; and
performing a load balancing operation at the first load balancer to control forwarding of the initial connection packet of the stateful-connection protocol toward a set of second load balancers configured to perform load balancing across respective subsets of processing elements of the set of processing elements.

20. A computer-readable storage medium storing instructions which, when executed by a computer, cause the computer to perform a method, the method comprising:
receiving an initial connection packet of a stateful-connection protocol at a first load balancer configured to perform load balancing across a set of processing elements, the initial connection packet of the stateful-connection protocol configured to request establishment of a stateful connection; and
performing a load balancing operation at the first load balancer to control forwarding of the initial connection packet of the stateful-connection protocol toward a set of second load balancers configured to perform load balancing across respective subsets of processing elements of the set of processing elements.
